(19) United States
(12) Patent Application Publication
(10) Pub. No.: US 2024/0411091 A1
(43) Pub. Date: Dec. 12, 2024

(54) Mode Converter for BTO-based Electro-optic Devices and Method of Fabrication Thereof

(71) Applicant: Lumiphase AG, Stäfa (CH)

(72) Inventors: Stefan Abel, Zürich (CH); Felix Eltes, Zürich (CH); Loris Grandjean, Lausanne (CH); Lukas Kranz, Luzern (CH)

(21) Appl. No.: 18/657,174

(22) Filed: May 7, 2024

Related U.S. Application Data
(60) Provisional application No. 63/472,309, filed on Jun. 11, 2023.

(51) Int. Cl. G02B 6/42

(52) U.S. Cl. CPC G02B 6/4201

(57) ABSTRACT

A mode converter and method for fabrication that that allows efficient coupling from a standard SiN waveguide as is desirable (for edge or inter layer coupling) to a hybrid BTO/SiN waveguide (needed for efficient phase shifters).

### RELATED APPLICATIONS

This application claims the benefit under 35 USC 119(e) of U.S. Provisional Application No. 63/472,309, filed on Jun. 11, 2023, which is incorporated herein by reference in its entirety.

### BACKGROUND OF THE INVENTION

Silicon photonics have become a platform for dense and low-cost photonic integrated circuits (PIC) for a wide range of applications that, in many cases, require fast and energy-efficient electro-optical (EO) switches.

Silicon modulators have major constraints, however. Fast modulation of only the optical phase is not possible, as changes in real and imaginary parts of the refractive index are linked. In addition, their operating speed is limited by charge-carrier lifetimes in forward-biased or reverse-biased devices. The silicon based state-of-the-art modulators are often based on differently doped regions in the waveguides. Higher doping is required for higher speed operation, but higher doping increases absorption. Another option is heater-based devices. Here, a heater (often metal wire) changes the temperature via Joule heating (an electrical current), and consequently changes the temperature in a waveguide in close proximity but far enough that the optical mode does not see the strongly optically absorbing heater conductor. Such heater-based devices tend to be slow, have high power consumption, and can suffer from crosstalk.

Pockels materials avoid these problems. In such materials, a change of the refractive index is induced by an electric field. But no Pockels effect exists in a centrosymmetric crystal such as silicon. Thus, materials with sizeable Pockels coefficients must be integrated onto silicon photonic structures to combine the benefits of bulk Pockels modulators with the low fabrication costs of integrated silicon photonics.

Several approaches exist for integrating a material with a large effective Pockels effect in silicon based modulators. For example, the Pockels effect is present in lithium niobate (LiNbO₃, LN) single crystals. And, lithium niobate has been integrated with silicon waveguides, e.g. via wafer bonding techniques. However, the size mismatch between LN wafers and silicon wafers renders the integration process difficult to scale to large substrate sizes, which results in rather high chip costs.

Barium titanate (BaTiO₃, BTO), for several reasons, has emerged to enable Pockels-effect-based devices on silicon. First, BTO has one of the largest Pockels coefficients. Second, it has previously been used in thin-film EO modulators on small-size oxide substrates. Third, BTO may be grown on silicon substrates with large wafer sizes, and with excellent crystal quality, and so forth. In fact, BTO-based photonic electro-optic components on silicon wafers have been demonstrated with high performance.

In PICs, optical waveguides enable the transmission and manipulation of light signals. These waveguides are structures specifically designed to guide and confine light within the waveguide material, making them essential building blocks in PICs. The relationship between optical waveguides and the optical modes that propagate within these waveguides is fundamental to the functionality of PICs, as it defines the way light is transmitted and controlled within the circuit.

The propagation of optical modes within waveguides is determined by the waveguide's geometry, refractive index profile, and the wavelength of the light. Core and cladding materials of a waveguide create a refractive index contrast, which results in total internal reflection, allowing the light to be confined and guided within the core.

Mode converters are helpful when transmitting light between waveguides made of different materials such as between a SiN waveguide and a Pockels material-based waveguide. The optical modes supported by each waveguide can differ significantly due to variations in the materials' properties, such as refractive index and desired modulator geometry. These differences can lead to inefficient coupling and increased losses when light is transferred directly between two dissimilar waveguides. The primary function of a mode converter is to provide an efficient interface for light to couple between the different waveguides by matching the spatial distribution and phase profile of the optical modes in both waveguides. This ensures minimal loss and reflection and thus maximum transfer of optical power between the waveguides.

There are several reasons why mode converters are required when transmitting light between waveguides made of different materials. These include refractive index mismatch. Different materials generally have different refractive indices, which affect the mode profiles and the effective refractive index of the supported modes. A mismatch in the effective refractive index can cause reflections and high coupling losses at the waveguide interface. A mode converter can gradually change the mode profile and the effective mode index, enabling smooth transition and minimal loss. Another reason is waveguide geometry mismatch. Waveguides made of different materials may have different cross-sectional geometries and dimensions, affecting the supported modes and their confinement. A mode converter can adapt the geometries of the incoming and outgoing waveguides, providing a gradual transition that ensures efficient coupling between the modes.

### SUMMARY OF THE INVENTION

Typical mode converters include tapered structures that are placed in different photonic layers. There are two major challenges, however. Structuring small tips for tapers is difficult from a process point of view, especially for some material classes. Secondly, the tapers are made in different layers, and hence require more complex fabrication processes to form several waveguiding layers, and require good alignment relative to each other (otherwise losses may increase). Such alignment requirements impose difficulties for the fabrication.

Other mode converter architectures are used when coupling edge-to-edge. This requires very precise alignment between two mask sets during the fabrication process, and a very precise etch control, to avoid any gaps or overlaps. Structuring a waveguide across the “edge” of another waveguide is very untypical for process control reasons.

In general, when transferring light between waveguides with different mode sizes, such as a large mode diameter in a silicon nitride (SiN) waveguide and a smaller mode size in a barium titanate (BTO)-based waveguide, efficient coupling is crucial to minimize losses and ensure optimal device performance. Another example is transferring light between waveguides of different symmetries and hence different shapes of the waveguide profiles, e.g. between a fully etched ridge waveguide and a strip-loaded or rib waveguide. In those cases, a mode converter is required to adapt the larger mode profile of the SiN waveguide to the smaller mode profile of the BTO-based waveguide.

One common approach to achieve efficient mode conversion between such waveguides is to use an adiabatic taper. The adiabatic taper is a waveguide section that gradually narrows from the wider SiN waveguide to the narrower BTO-based waveguide, ensuring that the mode profile is smoothly transformed from one waveguide to the other. The taper must be designed such that the transition is slow enough for the mode to adapt adiabatically, which means that the mode remains in its fundamental state during the transition, minimizing losses due to mode mismatch.

The present invention concerns strip-loaded waveguides including Pockels materials such as BTO-based strip-loaded waveguides including a planar layer of BTO for the vertical confinement of light and a structured layer of silicon nitride on top of the BTO. The silicon nitride layer provides lateral and directional confinement of light.

In other examples, other variations of Pockels material are used such as different possible composition of (B,S)TO ((Ba,Sr)TiO3) including possible doping elements.

The present invention concerns the challenge of transferring light from a first waveguide to a second waveguide in an integrated photonic circuit, where both waveguides are essentially at the same level of the layer stack of that circuit, and where the second waveguide is built partially from the same layer(s) as the first waveguide.

The problem arises because different photonic circuits have different optimal optical modes and thus their waveguides. For example, SiN waveguides will typically be optimized for low loss. Contrastingly, in photonic circuits including modulators with Pockels materials waveguides and optical modes will typically be designed to be small to maximize the Pockels effect on the optical signals in the waveguides.

The optical signals also need to be coupled across different devices and waveguides made from different material layers. Inter layer coupler are additionally often required to couple the optical signals between different levels of waveguides, and/or across patterned edges of layers.

The present invention addresses the need for a simple and compact converters of the modes between different waveguides in an integrated circuit.

In specific example, the present invention is employed when a first waveguide is formed from a subset of the layers of a second waveguide. It is also relevant when the transition between first waveguide and a second waveguide uses the same subset of layers in a single fabrication step, and without planarization.

In general, according to one aspect, the invention features a mode coupler for an electro-optic device for coupling light with a waveguide including Pockels material layer, the mode coupler including waveguides that are essentially at the same level of the layer stack of that circuit, and where second waveguide is built partially from the same layer(s) as a first waveguide.

In general, according to another aspect, the invention features a mode coupler for an electro-optic device for coupling light with a waveguide including Pockels material. This mode coupler comprises a Pockels material layer and a waveguide layer that extends over a leading edge of the Pockels material layer.

In embodiments, the waveguide layer is silicon nitride and/or the Pockels material is BTO.

According further aspects of different embodiments, a lower cladding layer is provided in which the waveguide layer is deposited on the lower cladding layer in a first portion of the mode coupler and the Pockels material layer is deposited on the lower cladding layer in a second portion of the mode coupler, with the waveguide layer being deposited on the Pockels material layer in the second portion.

A bevel can be added on the leading edge of the Pockels material layer. Also, often the waveguide layer is wider around the leading edge of the Pockels material layer. In addition, the leading edge of the Pockels material layer might be surrounded on the lateral sides and the top by the waveguide layer. Further, an angle and/or point could be added on the leading edge of the Pockels material layer.

Still further, a thickness of the Pockels material layer can be reduced in and around the leading edge of the Pockels material layer.

In general, according to another aspect, the invention features a mode converter for an integrated photonic circuit comprising a first waveguide made from a first material, a second waveguide made from the first material and a second material in which the second waveguide is partially formed from the same layer as the first waveguide. A transition region is further provided between the first waveguide and the second waveguide, wherein the transition region is formed from a subset of the layers of the second waveguide.

In general, according to another aspect, the invention features an integrated photonic circuit comprising a first waveguide of a first material, a second waveguide of the first material and a second material, wherein the second waveguide is partially derived from the same layer as the first waveguide. A mode converter is provided between the first waveguide and the second waveguide, wherein the mode converter includes a transition region.

In general, according to another aspect, the invention features a method of fabricating a mode converter for an integrated photonic circuit. This method comprises forming a waveguide from silicon nitride that extends from a first section on a lower cladding layer to a second section on a Pockels material. Further the silicon nitride is patterned with an expanded portion and/or the Pockels material is patterned with an expanding portion.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are a top view and a side cross-sectional view showing a mode coupler between a silicon nitride SiN waveguide and a waveguide fabricated from SiN and Pockels material such as a BTO according to the present invention;

FIG. 2 is a combined drawing showing the relationship between a top view (top portion of the figure) and a side cross-sectional view (bottom portion of the figure) for another embodiment of the mode coupler;

FIG. 3 is a combined drawing showing the relationship between a top view (lower part of figure) and a side cross-sectional views at different positions along the length of the mode coupler showing another embodiment of the mode coupler; and

FIG. 4 is a combined drawing showing the relationship between a top view (lower part of figure) and a side cross-sectional view (upper part of figure) of the mode coupler showing another embodiment of the mode coupler.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

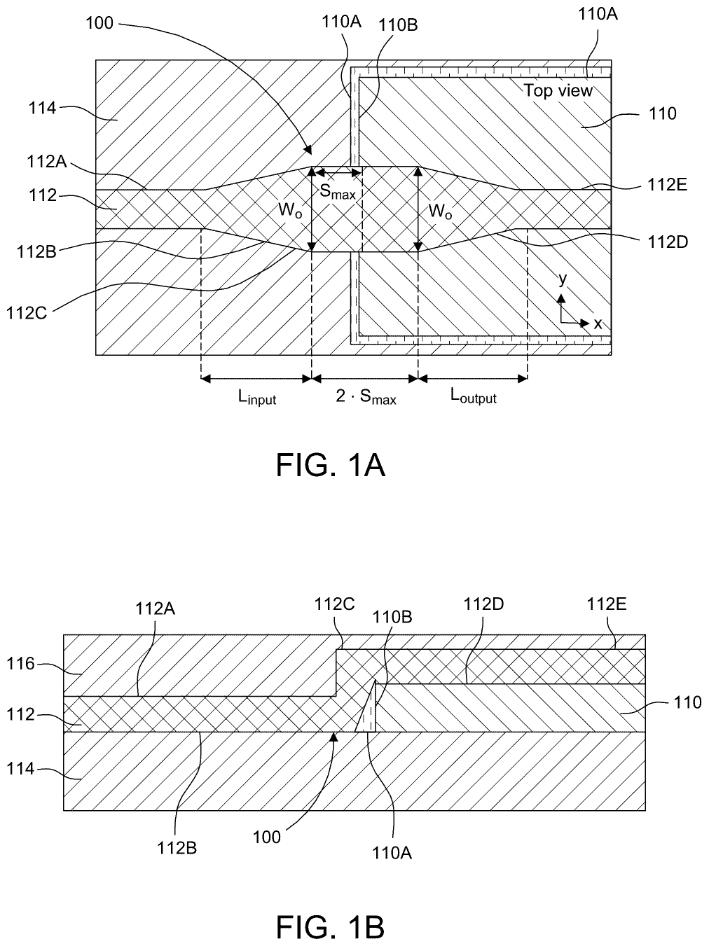

FIGS. 1A and 1B are a top view and a side cross-sectional view showing a mode coupler 100 between a silicon nitride SiN waveguide and a waveguide fabricated from SiN and Pockels material such as a BTO.

The mode coupler 100 addresses the problem that arises when the SiN waveguide crosses a “sharp” edge between BTO region (right side) and no-BTO region (left side). The leading edge 110B of the BTO can be a rather lossy transition. The mode coupler thus converts light from one photonic layer (SiN) (left side) to another one, SiN-on-BTO, (right side) in an efficient way. The silicon nitride layer 112 extends continuously across the mode coupler 100 and the bottom interfaces of the BTO 110 and SiN 112 are vertically self-aligned on both sides of the mode coupler, being both deposited on lower cladding layer 114.

In the illustrated example, the silicon nitride waveguide 112 is formed on a silicon oxide layer 114, that functions as the lower cladding layer. The transition is to a combined waveguide including the silicon nitride layer 112 on a BTO layer 110. Note that in some examples, a passivation layer is present between the silicon nitride layer 112 on BTO layer 110 as described in U.S. Prov. Pat. Appl. No. 63/502,425, filed on May 16, 2023, which is incorporated herein by this reference in its entirety.

In the illustrated example, the mode coupler 100 includes an expanding section 112B in which the width of the SiN waveguide is slowly increased moving along the extent of the waveguide. This transitions to an expanded section 112C where the mode coupler reaches its greatest width. Thereafter, as the waveguide begins to extend over the BTO layer 110, the mode converter includes a contracting section 112D that terminates and tapers into an internal waveguide section 112E including a SiN layer on the BTO layer 110. A second silicon oxide layer 116 is deposited over the silicon nitride waveguide 112 as an upper cladding layer.

As better shown in cross section, the silicon nitride 112 exists in a continuous layer that extends from being in contact with the silicon oxide layer 114 and stretching over the BTO layer 110 in a conformal deposition process. In this way, the optical mode is smoothly transitioned between the silicon nitride portion of the waveguide 112A and the combined BTO-silicon nitride portion 112E.

Preferably, a beveled portion 110A is formed as part of the BTO layer 110 or a separate material. This smooths the hard leading edge 110B of the BTO layer 110 to improve efficient propagation of the optical mode.

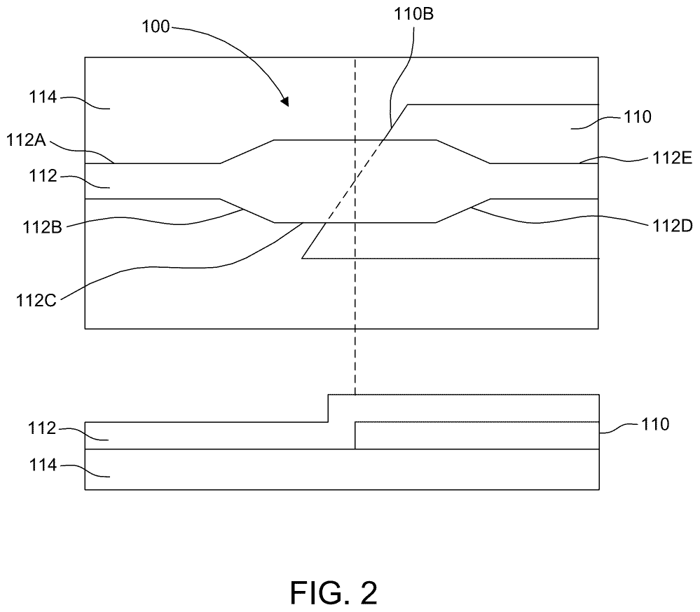

FIG. 2 shows another embodiment of the mode converter 100.

Here also, the silicon nitride 112 exists in a continuous layer that extends from being in contact with the silicon oxide layer 114 to climbing up and over the BTO layer 110 in a conformal deposition process such that the material forming silicon nitride waveguide 112 was deposited in a single deposition step for both on the portion on silicon oxide 114 and the portion on the BTO 110.

The BTO layer has an angled leading edge 110B to further smooth the transition. The angled leading edge 110B is angled in the plane of the layers as shown in the figure.

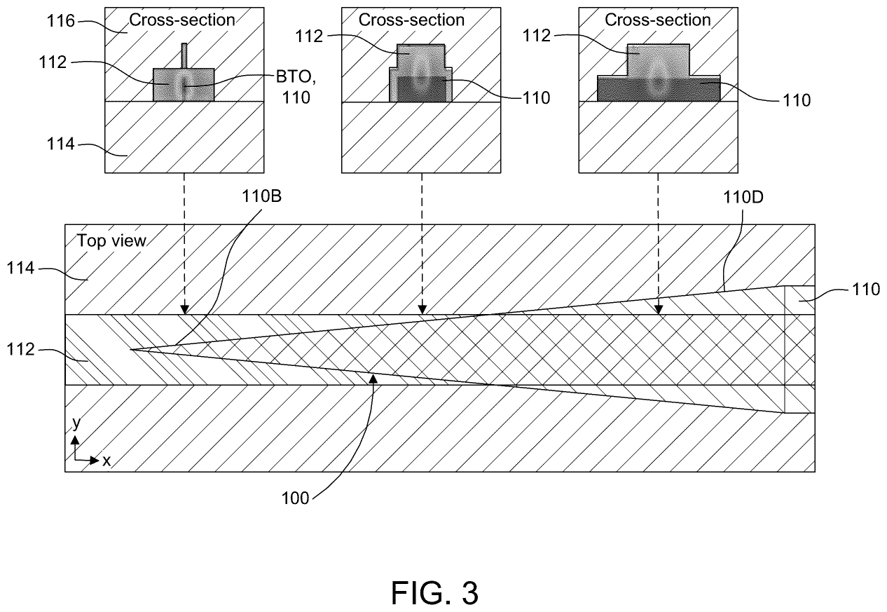

FIG. 3 shows another embodiment of the mode converter 100.

In this example, the BTO layer 110 forms a point profile 110D. This point narrows in the direction of the SiN-only portion (left side) of the waveguide 112.

The insets illustrate the transition between silicon nitride waveguide 112 as formed on a silicon oxide layer 114 to the combined waveguide including the silicon nitride 112 on BTO layer 110.

The silicon nitride layer is draped on top of the pointed profile 110D as part of a conformal deposition process. Initially, the pointed profile forms only a small section of the waveguide width. But this increases in the direction of the combined waveguide.

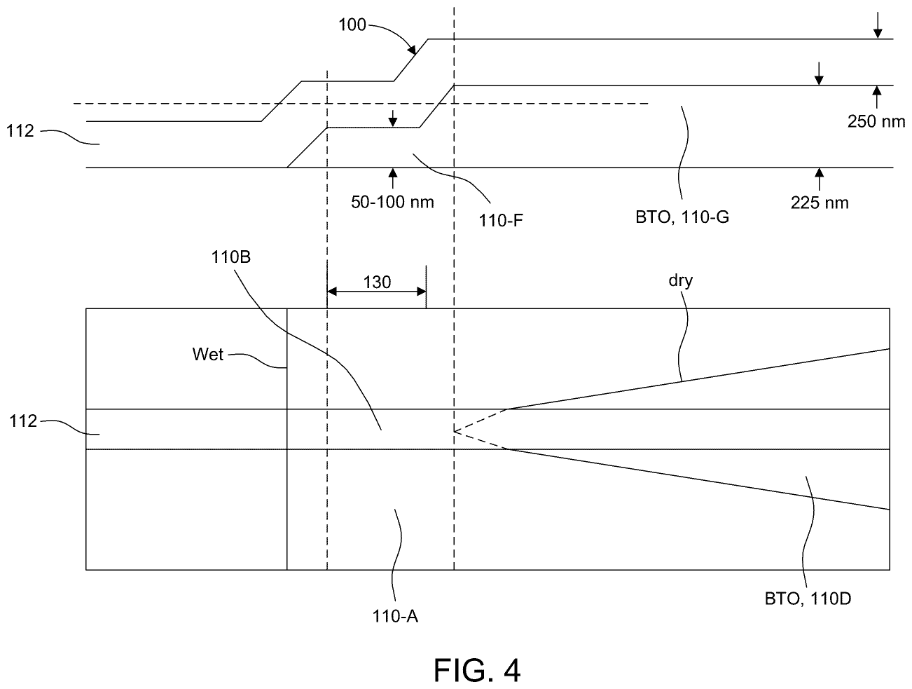

FIG. 4 shows another example of the mode converter 100.

Here, the SiN waveguide 112 “climbs” on top of the BTO 110 in two steps moving from left to right. The BTO layer forms a staircase starting with its leading edge portion 110B.

In more detail, from the left, the SiN waveguide 112 climbs on BTO with thickness of around 50-100 nm in region 130. In a second step, SiN waveguide 112 climbs on the full BTO layer thickness of 225 nm, for example.

In general, a dry etch is used to form a pointed profile 110D of the BTO layer, leaving a thin flat BTO layer portion 110-A/110-F. Then in a second step, a wet etch removes BTO on the left of the line indicated “wet” and leaving thin BTO everywhere else on the drawing (around the tip). The SiN waveguide 112 is formed in a third step so that the BTO extends like a tongue under the SiN waveguide 112.

In summary, the disclosed mode converters can be fabricated from a standard SiN waveguide as is desirable (for edge or inter layer coupling) to a hybrid BTO/SiN waveguide (needed for efficient phase shifters).

While this invention has been particularly shown and described with references to preferred embodiments thereof, it will be understood by those skilled in the art that various changes in form and details may be made therein without departing from the scope of the invention encompassed by the appended claims.

What is claimed is:

1. A mode coupler for an electro-optic device for coupling light with a waveguide including Pockels material layer, the mode coupler including waveguides that are essentially at the same level of the layer stack of that circuit, and where second waveguide is built partially from the same layer(s) as a first waveguide.

2. A mode coupler for an electro-optic device for coupling light with a waveguide including Pockels material, the mode coupler comprising:
a Pockels material layer; and
a waveguide layer that extends over a leading edge of the Pockels material layer.

3. The mode coupler as claimed in claim 2, wherein the waveguide layer is silicon nitride and/or the Pockels material is BTO.

4. The mode coupler as claimed in claim 2, further comprising a lower cladding layer, wherein the waveguide layer is deposited on the lower cladding layer in a first portion of the mode coupler and the Pockels material layer is deposited on the lower cladding layer in a second portion of the mode coupler, with the waveguide layer being deposited on the Pockels material layer in the second portion.

5. The mode coupler as claimed in claim 2, further comprising a bevel on the leading edge of the Pockels material layer.

6. The mode coupler as claimed in claim 2, wherein the waveguide layer is wider around the leading edge of the Pockels material layer.

7. The mode coupler as claimed in claim 2, wherein the leading edge of the Pockels material layer is surrounded on the lateral sides and the top by the waveguide layer.

8. The mode coupler as claimed in claim 2, further comprising an angle on the leading edge of the Pockels material layer.

9. The mode coupler as claimed in claim 2, further comprising a point on the leading edge of the Pockels material layer.

10. The mode coupler as claimed in claim 2, wherein a thickness of the Pockels material layer is reduced in around the leading edge of the Pockels material layer.

11. A mode converter for an integrated photonic circuit, comprising:
a first waveguide made from a first material;
a second waveguide made from the first material and a second material, the second waveguide being partially formed from the same layer as the first waveguide;
a transition region between the first waveguide and the second waveguide, wherein the transition region is formed from a subset of the layers of the second waveguide.

12. The mode converter of claim 11, wherein the first material is Silicon Nitride (SiN).

13. The mode converter of claim 11, wherein the second material is a Pockels material.

14. The mode converter of claim 13, wherein the Pockels material is Barium Titanate (BTO).

15. The mode converter of claim 11, wherein the transition region includes an adiabatic taper.

16. The mode converter of claim 11, wherein the first waveguide and the second waveguide are at the same level in a layer stack of the integrated photonic circuit.

17. An integrated photonic circuit comprising:
a first waveguide of a first material;
a second waveguide of the first material and a second material, wherein the second waveguide is partially derived from the same layer as the first waveguide;
a mode converter between the first waveguide and the second waveguide, wherein the mode converter includes a transition region.

18. A method of fabricating a mode converter for an integrated photonic circuit, the method comprising:
forming a waveguide from silicon nitride that extends from a first section on a lower cladding layer to a second section on a Pockels material; and
patterning the silicon nitride with an expanded portion and/or patterning the Pockels material with an expanding portion.
